(19) United States
(12) Patent Application Publication
(10) Pub. No.: US 2025/0337160 A1
(43) Pub. Date: Oct. 30, 2025

(54) ANTENNA DEVICE

(71) Applicant: KMW INC., Hwaseong-si (KR)

(72) Inventors: Young Chan Moon, Suwon-si (KR); Sung Hwan SO, Hwaseong-si (KR); Oh Seog CHOI, Hwaseong-si (KR); Hun Jung JUNG, Hwaseong-si (KR); Gyo Jin JO, Hwaseong-si (KR); Seong Han SON, Yongin-si (KR); Nam Jik KIM, Hwaseong-si (KR)

(73) Assignee: KMW INC., Hwaseong-si (KR)

(21) Appl. No.: 19/263,545

(22) Filed: Jul. 9, 2025

Related U.S. Application Data
(63) Continuation of application No. PCT/KR2024/000377, filed on Jan. 9, 2024.

(30) Foreign Application Priority Data
Jan. 9, 2023 (KR) 10-2023-0003066
Jan. 8, 2024 (KR) 10-2024-0002783

(51) Int. Cl. H01Q 1/52; H01Q 5/307; H01Q 9/04

(52) U.S. Cl. CPC H01Q 1/523; H01Q 5/307; H01Q 9/0407

(57) ABSTRACT

The present disclosure relates to an antenna device, comprising a first antenna patch panel configured to radiate an operating frequency of a first frequency band; and at least one second antenna patch panel configured to radiate an operating frequency greater than the first frequency band; wherein the first antenna patch panel is provided with a frequency selective transmission pattern part for transmitting a beam of an operating frequency radiated from the second antenna patch panel (hereinafter referred to as a ‘middle beam’); and wherein the frequency selective transmission pattern part is provided in a conductive pattern form on a portion of the first antenna patch panel that entirely or at least partially overlaps the radiation direction of the middle beam of the second antenna patch panel, thereby providing advantages such as preventing product size expansion and improving signal quality.

### TECHNICAL FIELD

The present disclosure relates to an antenna device, and more particularly, to an antenna device capable of maximizing beamforming characteristics by minimizing interference of radiation beams between antenna patch panels configured to cover multiple frequency bands.

### BACKGROUND ART

Recently, as an antenna device for mobile communication base stations and Wi-Fi communication equipment antenna devices, multi-band antenna devices capable of communicating in a plurality of frequency bands to ensure communication capacity have been practically deployed.

FIG. 1 is an exemplary plan view (a) and perspective view (b) illustrating an arrangement of antenna patch panels among configurations of a conventional multi-band antenna device.

As shown in FIG. 1, a multi-band antenna device includes a plurality of dipole-type antenna patch elements to radiate beam patterns of operating frequencies in multiple frequency bands.

Such a multi-band antenna device forms an antenna array where cross dipole antenna patch elements for high bandwidth and low bandwidth (LB antenna: Low Band antenna, HB antenna: High Band antenna) are alternately arranged on a reflector.

Here, the arrangement of each antenna patch element of the HB antenna and LB antenna (hereinafter, the antenna patch element of the HB antenna is abbreviated as ‘HB element’, and the antenna patch element of the LB antenna is abbreviated as ‘LB element’) on the reflector is preferably configured to be as far apart as possible so that the beam patterns radiated from each patch element are formed directly without mutual interference.

However, the spaced arrangement of antenna patch elements inevitably leads to an increase in the overall product size. Recently, as shown in FIG. 1 (b), HB elements with a relatively small radiating surface area are arranged close to the reflector, and LB elements with a relatively large radiating surface area are arranged in front of the HB elements in the radiation direction.

In this case, however, at least a part of the beam patterns radiated by the HB elements overlaps due to the physical structural area of the relatively front-arranged LB elements, which leads to problems of distorted radiation patterns due to interference from the LB elements and deteriorated directivity.

### DISCLOSURE OF THE INVENTION

### Technical Problem

The present disclosure has been designed to solve the above technical problems, and its purpose is to provide an antenna device that can minimize interference of radiation beams between antenna patch panels configured to cover multiple frequency bands.

In addition, another object of the present disclosure is to provide an antenna device that can maximize the beamforming characteristics by artificially minimizing, through a wave-transmissible shape part, the frequency that interferes with the antenna patch panel of the low-frequency band (Low Band) among the frequencies of the high-frequency band (High Band or Middle Band) radiated in the radiation direction.

The objects of the present disclosure are not limited to those mentioned above, and other objects not mentioned will be clearly understood by those skilled in the art from the description below.

### Technical Solution

An antenna device according to an embodiment of the present disclosure includes a first antenna patch panel configured to radiate an operating frequency of a first frequency band, and at least one second antenna patch panel configured to radiate an operating frequency greater than the first frequency band. The first antenna patch panel is provided with a frequency selective transmission pattern part for transmitting a beam of an operating frequency radiated from the second antenna patch panel (hereinafter referred to as a ‘middle beam’), wherein the frequency selective transmission pattern part is provided in a conductive pattern form on a portion of the first antenna patch panel that entirely or at least partially overlaps the radiation direction of the middle beam of the second antenna patch panel.

In addition, an antenna device according to an embodiment of the present disclosure includes a first antenna patch panel configured to radiate an operating frequency of a first frequency band, at least one second antenna patch panel configured to radiate an operating frequency greater than the first frequency band, and at least one third antenna patch panel configured to radiate an operating frequency greater than the second frequency band. The first antenna patch panel is provided with at least one frequency selective transmission pattern part for transmitting at least one of a beam of an operating frequency radiated from the second antenna patch panel (hereinafter referred to as a ‘middle beam’) and a beam of an operating frequency radiated from the third antenna patch panel (hereinafter referred to as a ‘high beam’). The at least one frequency selective transmission pattern part is respectively provided in a conductive pattern form on a portion of the first antenna patch panel that entirely or at least partially overlaps the radiation direction of the middle beam of the second antenna patch panel or the high beam of the third antenna patch panel.

Here, some of the frequency selective transmission pattern parts may be provided in a processed form of at least one wave-transmissible shape part formed such that its shape from the input terminal to the output terminal of the radiation frequency is perfectly symmetrical with respect to an arbitrary reference line, so that the operating frequency forming the middle beam of the second antenna patch panel can be transmitted.

In addition, the frequency selective transmission pattern part may include four external wave-transmissible patterns formed to have square conductive edges associated with the middle beam and provided on the first antenna patch panel, and four internal wave-transmissible patterns formed to have square conductive inner surfaces associated with the middle beam, spaced apart from the four external wave-transmissible patterns by an open circuit, and provided on the first antenna patch panel as an inner part of each of the external wave-transmissible patterns. The wave-transmissible shape part may be provided in the external wave-transmissible pattern.

In addition, the frequency selective transmission pattern part may include four external wave-transmissible patterns formed to have square conductive edges associated with at least one of the middle beam and the high beam and provided on the first antenna patch panel; and four internal wave-transmissible patterns formed to have square conductive inner surfaces associated with at least one of the middle beam and the high beam, spaced apart from the four external wave-transmissible patterns by an open circuit, and provided on the first antenna patch panel as an inner part of each of the external wave-transmissible patterns. The wave-transmissible shape part may be provided in the external wave-transmissible pattern.

In addition, each of the four external wave-transmissible patterns may be connected to be fed by a balun part provided to support the first antenna patch panel.

In addition, the wave-transmissible shape part may be formed in a wave-transmissible groove that is a part of the square conductive edge of the external wave-transmissible pattern cut open inwardly.

In addition, the wave-transmissible shape part may include a wave-transmissible end having at least one bending end on one side and the other side when the exact center portion between one side wall and the other side wall of the wave-transmissible groove is the arbitrary reference line, and a wave-transmissible connection end extending from the wave-transmissible groove and including a frequency input terminal and a frequency output terminal that respectively connect the left and right sides of the wave-transmissible end.

In addition, the frequency input terminal and the frequency output terminal of the wave-transmissible connection end may be processed and formed to be separated in a form where a part of the external wave-transmissible pattern is cut based on the arbitrary reference line.

In addition, the wave-transmissible end may be formed such that its inner end is accommodated entirely within the wave-transmissible groove.

In addition, the wave-transmissible end may be formed to have at least two bending ends on one side and the other side respectively with respect to the arbitrary reference line, and at least two bending ends of the wave-transmissible end generated from the wave-transmissible connection end may be accommodated entirely within the wave-transmissible groove.

In addition, the wave-transmissible end may be designed such that its inner end protrudes inwardly beyond the wave-transmissible groove and into the external wave-transmissible pattern, but the length of protrusion from the boundary of the wave-transmissible groove does not exceed the depth of the wave-transmissible groove.

In addition, the wave-transmissible shape part may be formed in two stages such that the wave-transmissible connection end and the wave-transmissible end are further added to the inner end of the wave-transmissible end.

In addition, the wave-transmissible shape part may include a middle beam wave-transmissible part related to the wave transmission of the middle beam and a high beam wave-transmissible part related to the wave transmission of the high beam, and the length of the inner end of the middle beam wave-transmissible part may be formed to be longer than the length of the inner end of the high beam wave-transmissible part.

In addition, the middle beam wave-transmissible part and the high beam wave-transmissible part may be simultaneously formed to be spaced apart on the same side of the square conductive edge.

### Advantageous Effects

According to an embodiment of the present disclosure, an antenna device can achieve various effects as follows.

First, by improving the interference phenomenon caused by the overlapping of beam patterns radiated at a relatively high-frequency band, the arrangement of multiple antenna patch panels configured to cover multiple frequency bands can be concentrated, thereby easily reducing the overall product size.

Second, by allowing the middle frequency and high-frequency bands to pass through the antenna patch panel that forms a beam pattern with a low-frequency band operating frequency, the designer can form a desired good beam pattern (beamforming), which has the effect of improving signal quality.

### BRIEF DESCRIPTION OF THE DRAWINGS

FIG. 1 is an exemplary plan view (a) and perspective view (b) illustrating an arrangement of antenna patch panels among configurations of a conventional multi-band antenna device;

FIG. 2 is a perspective view illustrating an antenna board assembly among configurations of an antenna device according to an embodiment of the present disclosure;

FIG. 3 is a plan view of FIG. 2;

FIG. 4 is a front view of FIG. 2;

FIG. 5 is a perspective view illustrating a first antenna patch panel among configurations of FIG. 2;

FIG. 6 is an exploded perspective view of FIG. 5;

FIG. 7 is a front view of FIG. 5;

FIGS. 8a and 8b are exploded perspective views of one side and the other side of a disassembled balun part among configurations of FIG. 6;

FIG. 9 is a plan view illustrating a wave-transmissible shape part among configurations of FIG. 5;

FIG. 10 is a frequency characteristic diagram illustrating a transmission band according to FIG. 9;

FIG. 11 is a plan view illustrating first to third variations of the wave-transmissible shape part of FIG. 9;

FIG. 12a is an arrangement diagram of the first to third antenna patch panels according to the presence or absence of the wave-transmissible shape part according to an embodiment of the present disclosure; and

FIG. 12b is a beamforming diagram reflecting the result values of beam patterns (beamforming) according to the presence or absence of the wave-transmissible shape part of FIG. 12a.

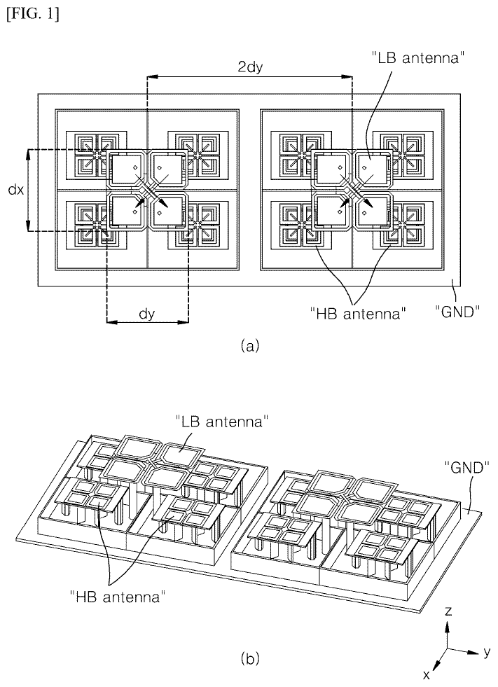

### DESCRIPTION OF REFERENCE NUMERALS

5: Reflector, 10: First antenna patch panel
10B: Low beam, 20: Second antenna patch panel
20B: Middle beam, 30: Third antenna patch panel
30B: High beam, 50: Balun part
51: First balun support, 52: Second balun support
100: Frequency selective transmission pattern part, 120: External wave-transmissible pattern
121: Wave-transmissible groove 123: Wave-transmissible end
124a, 124b: Wave-transmissible connection end 125: Wave-transmissible shape part
127: Conductive edge 130: Internal wave-transmissible pattern

### BEST MODE FOR CARRYING OUT THE INVENTION

Hereinafter, an antenna device according to an embodiment of the present disclosure will be described in detail with reference to the accompanying drawings.

When adding reference numerals to the components in each drawing, it should be noted that the same components, even if shown in different drawings, are assigned the same reference numerals as much as possible. In addition, in describing embodiments of the present invention, if a detailed description of a related known configuration or function is deemed to hinder understanding of the embodiments of the present invention, the detailed description thereof will be omitted.

In describing the components of the embodiments of the present disclosure, terms such as first, second, A, B, (a), (b), etc. may be used. These terms are merely for distinguishing one component from other components, and do not limit the essence, order, or sequence of the component by the terms. In addition, unless otherwise defined, all terms used herein, including technical or scientific terms, have the same meaning as commonly understood by one of ordinary skill in the art to which this disclosure belongs. Terms such as those generally defined in dictionaries should be interpreted as having a meaning consistent with the meaning in the context of the related art, and should not be interpreted in an idealized or excessively formal sense unless explicitly defined in this application.

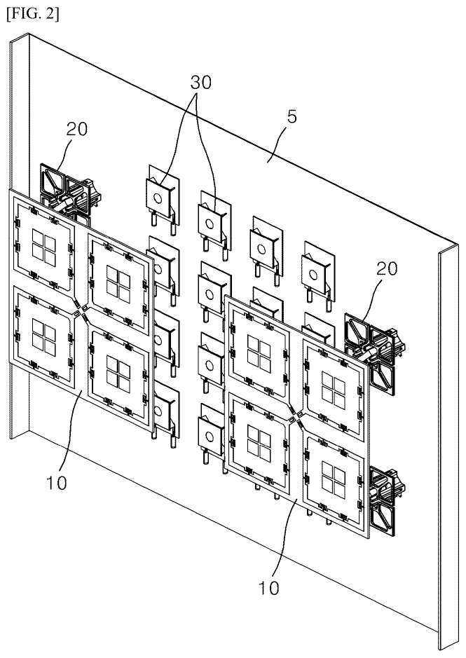

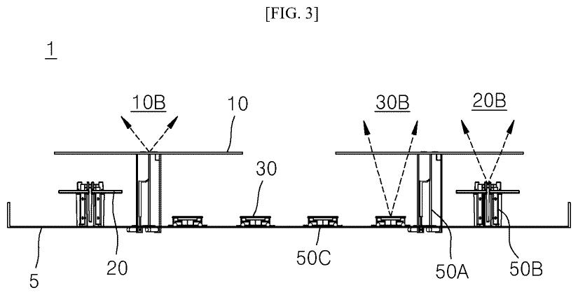

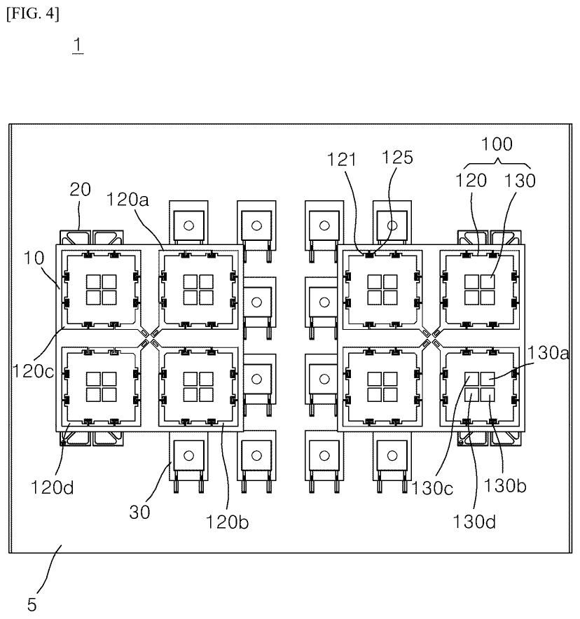

FIG. 2 is a perspective view illustrating an antenna board assembly among configurations of an antenna device according to an embodiment of the present invention, FIG. 3 is a plan view of FIG. 2, and FIG. 4 is a front view of FIG. 2.

An antenna device according to an embodiment of the present disclosure may be an antenna device reflecting multiple-input multiple-output (MIMO) technology.

MIMO technology is a technology that significantly increases data transmission capacity by using a plurality of array antenna elements, and it is a spatial multiplexing technique in which a transmitter transmits different data through each transmit antenna, and a receiver distinguishes transmit data through appropriate signal processing.

Therefore, as the number of transmit and receive antennas (the number of antenna patch panels to be described later) is simultaneously increased, the channel capacity increases, allowing more data to be transmitted. For example, if the number of antennas is increased to 10, approximately 10 times the channel capacity may be secured using the same frequency band compared to a single antenna system.

In particular, the antenna device may arrange TRx modules (not shown) performing transmitter and receiver functions in a V (Vertical)-H (Horizontal) array in the vertical and horizontal directions, and arrange a plurality of antenna patch panels electrically connected to each TRx module.

Here, in a MIMO antenna device for mobile communication, a plurality of antenna patch panels are generally designed as a plurality of dual-polarized antenna module arrays to reduce fading effects due to multipath and to perform polarization diversity functions.

More specifically, an antenna device according to an embodiment of the present disclosure may include an antenna housing part (not shown) forming the left and right sides and rear exterior of the antenna device, and a radome panel (not shown) forming the front exterior of the antenna device, provided to shield the opened front surface of the antenna housing part, and protecting internal components (e.g., RF filter and antenna board part) provided in the internal space of the antenna housing part from the outside.

Here, the functions and detailed features of the antenna housing part and the radome panel are very less related to the technical features of an embodiment of the present invention, so their detailed description will be omitted.

Meanwhile, the antenna device according to an embodiment of the present disclosure may be designed and arranged only as a single-band type in which a plurality of antenna patch panels radiate operating frequencies of the same frequency band. However, as shown in FIGS. 2 to 4, it may include antenna patch panels 10, 20, and 30 of various specifications to cover multiple frequency bands (multi-band).

That is, referring to FIG. 2, a reflector 5 configured to reflect radiated frequencies forward, which is the radiation direction, may be provided on the front surface of the antenna board part. On the front surface of the reflector 5, a first antenna patch panel 10 configured to radiate an operating frequency of a first frequency band, at least one second antenna patch panel 20 configured to radiate an operating frequency greater than the first frequency band, and at least one third antenna patch panel 30 configured to radiate an operating frequency greater than the second frequency band may be included.

Here, the first frequency band is a Low Band, forming a low-frequency band low beam pattern (beamforming) (10B, hereinafter abbreviated as ‘low beam’) by radiating a frequency defined between 600 MHz and 800 MHZ. The second frequency band is a Middle Band, forming a middle-frequency band middle beam pattern (beamforming) (20B, hereinafter abbreviated as ‘middle beam’) by radiating a frequency defined between 1.7 GHz and 2.4 GHz. The third frequency band is a High Band, forming a high-frequency band high beam pattern (beamforming) (30B, hereinafter abbreviated as ‘high beam’) by radiating a frequency defined between 3.4 GHz and 3.7 GHZ.

However, the range of each operating frequency band is relative, and in an embodiment of the present disclosure, it is preferable to understand that at least three antenna patch panels 10, 20 and 30 of different specifications are provided to cover different frequency bands.

Meanwhile, the first antenna patch panel 10, the second antenna patch panel 20, and the third antenna patch panel 30 may be adopted as dipole types among various types of antenna element specifications.

In particular, the first antenna patch panel 10, the second antenna patch panel 20, and the third antenna patch panel 30 may be adopted as polarized antennas capable of generating at least one polarization among dual polarizations. For example, they may be formed in a square or rectangular shape and radiate +45 polarization by being fed from one corner to the diagonally opposite corner, and similarly radiate −45 polarization by being fed from the remaining corner to the diagonally opposite remaining corner.

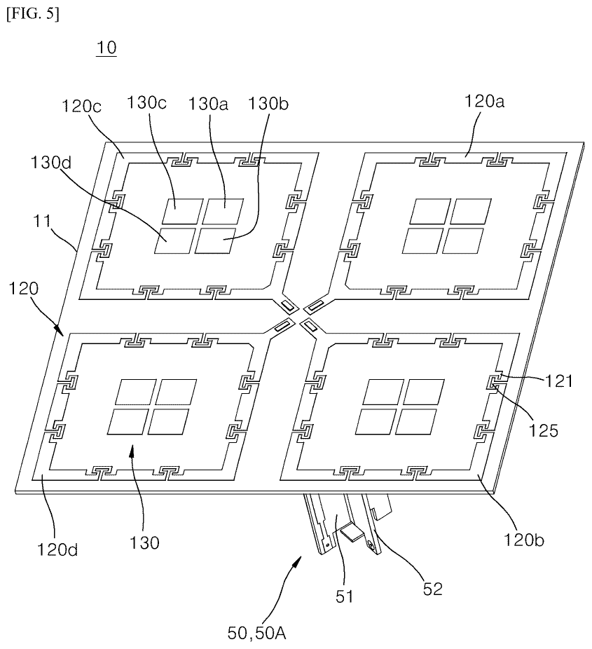

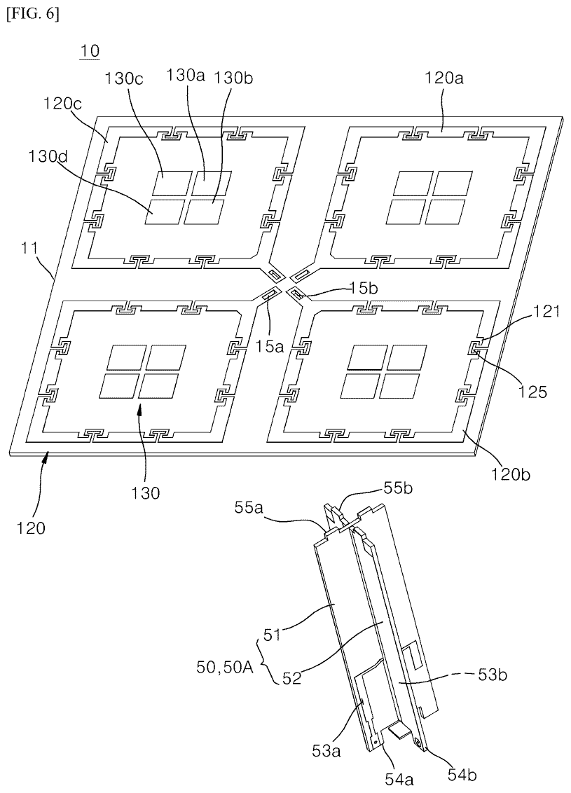

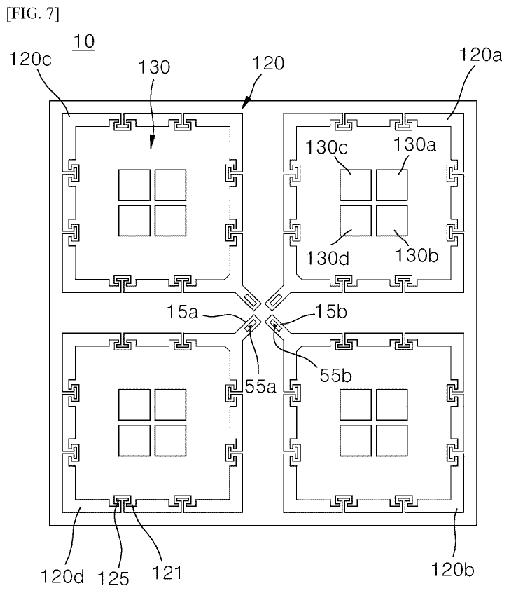

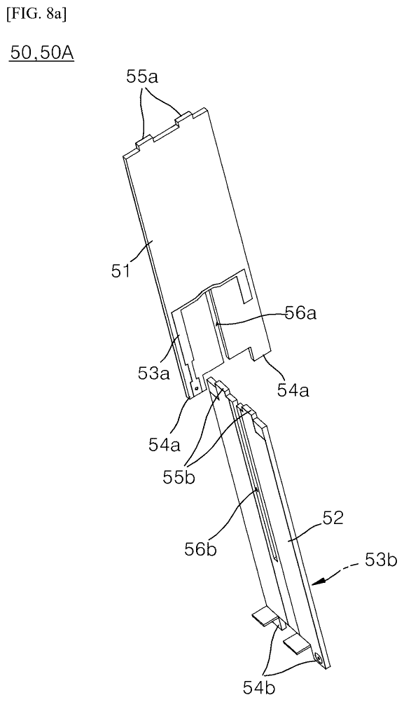

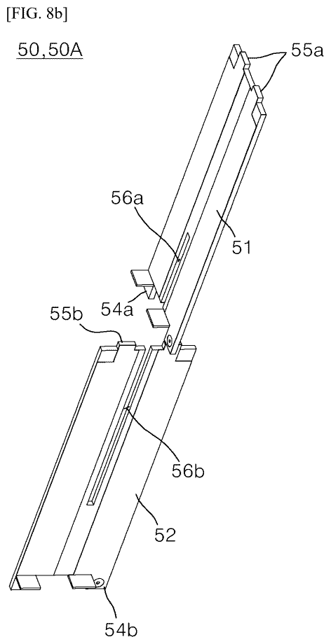

FIG. 5 is a perspective view illustrating the first antenna patch panel among the configurations of FIG. 2, FIG. 6 is an exploded perspective view of FIG. 5, FIG. 7 is a front view of FIG. 5, and FIGS. 8a and 8b are exploded perspective views of one side and the other side of the disassembled balun part among the configurations of FIG. 6.

The first antenna patch panel 10, the second antenna patch panel 20, and the third antenna patch panel 30 may be supported and fixed by a balun part 50 on which feeding patterns 53a and 53b are printed to facilitate their fixation at a predetermined distance from the front surface of the reflector 5, and to feed power to each antenna patch panel 10 to 30.

Here, the first antenna patch panel 10 is spaced parallel to the reflector 5 by the first balun part 50A at the farthest front from the reflector 5. The third antenna patch panel 30 is spaced parallel to the reflector 5 by the third balun part 50C at the closest front from the reflector 5. The second antenna patch panel 20 may be spaced parallel to the reflector 5 in the space between the first antenna patch panel 10 and the third antenna patch panel 30 by the second balun part 50B.

This is because the first antenna patch panel 10 radiating the low beam 10B of the low frequency band has the largest size (i.e., area of the radiating surface) corresponding to half a wavelength, so it is advantageous for beam pattern formation and interference avoidance to place the third antenna patch panel 30 having the relatively smallest size closest to the reflector 5.

However, as shown in FIG. 3, when the low beam 10B is radiated through the first antenna patch panel 10, there is no component that causes frequency interference in the front of the radiation direction, so it does not cause a significant problem. However, if the middle beam 20B of the second antenna patch panel 20 and the high beam 30B of the third antenna patch panel 30 are arranged to overlap the first antenna patch panel 10 in the radiation direction, there is a risk of reflection and distortion due to the metal (conductive) material forming the radiating surface of the first antenna patch panel 10, and in this case, the desired radiation of the middle beam 20B and high beam 30B by the designer does not occur.

For example, the first antenna patch panel 10 includes a conductor having a half-wavelength length. If the middle beam radiated from the second antenna patch panel 20 is radiated from the back side, most of the electromagnetic waves are reflected, changing the wave propagation state of the second antenna patch panel 20, thus acting as a factor that hinders the operation of the overlapping second antenna patch panel 20. This problem may also apply to the relationship between the first antenna patch panel 10 and the third antenna patch panel 30.

Meanwhile, the first antenna patch panel 10, the second antenna patch panel 20, and the third antenna patch panel 30, although differing somewhat in size and detailed shape, may be supported and coupled to the reflector 5 via the balun part 50 as shown in FIGS. 5 and 6.

Specifically, limiting to the first antenna patch panel 10, the balun part 50A includes a first balun support 51 and a second balun support 52 as shown in FIGS. 8a and 8b. The first balun support 51 and the second balun support 52 are coupled to have vertical cross-sections intersecting in an ‘X’ or ‘+’ shape, and are prepared in a PCB form, with feeding patterns 53a and 53b for the first antenna patch panel 10 from the antenna board part being pattern-printed on each surface.

As described above, a first coupling slit groove 56a and a second coupling slit groove 56b may processed and formed in the first balun support 51 and the second balun support 52 to allow them to be coupled in an intersecting manner.

In addition, as shown in FIGS. 5 to 8, a first rear fixing protrusion 54a and a second rear fixing protrusion 54b are formed at the rear end of the first balun support 51 and the second balun support 52 to penetrate the reflector 5 and be fixed to the antenna board part (not shown). A first front fixing protrusion 55a and a second front fixing protrusion 55b are formed at the front end to be respectively inserted into and coupled with a first fixing slot 15a and a second fixing slot 15b provided in the center of the first antenna patch panel 10.

Meanwhile, the balun part 50A supporting the first antenna patch panel 10 may mediate the connection to feed power to four external wave-transmissible patterns 120 among the frequency selective transmission pattern part 100 to be described later.

Detailed descriptions of the balun part 50B supporting the second antenna patch panel 20 and the balun part 50C supporting the third antenna patch panel 30 are omitted, but they have the same configuration and coupling structure as the balun part 50A supporting the first antenna patch panel 10 described above, differing only in the length between their front and rear ends relative to the reflector 5.

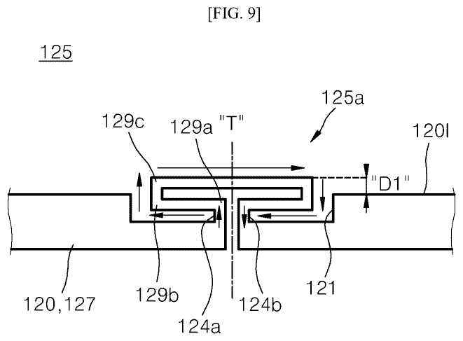

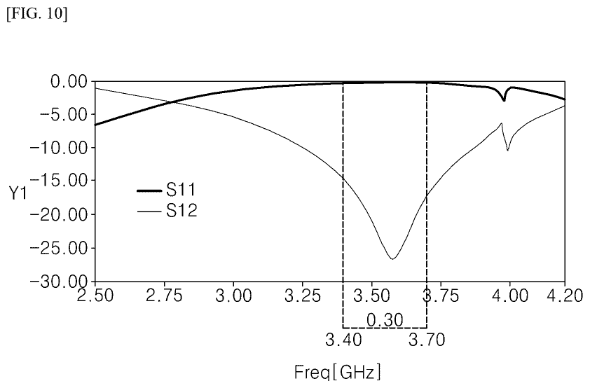

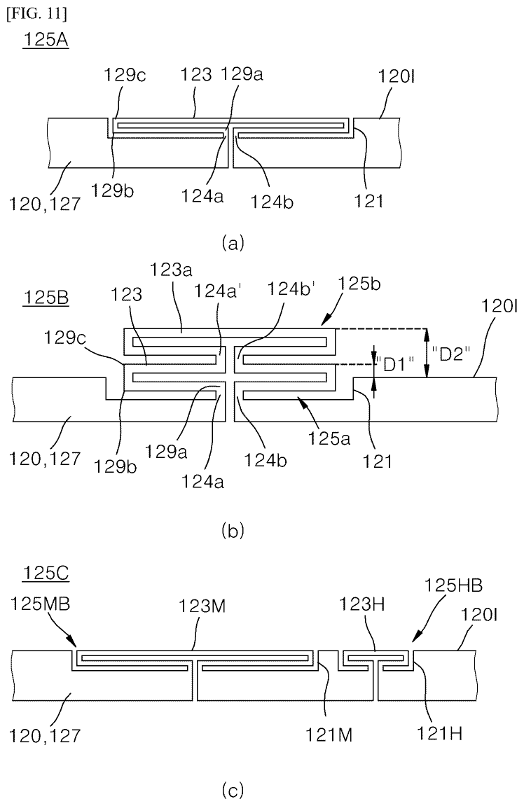

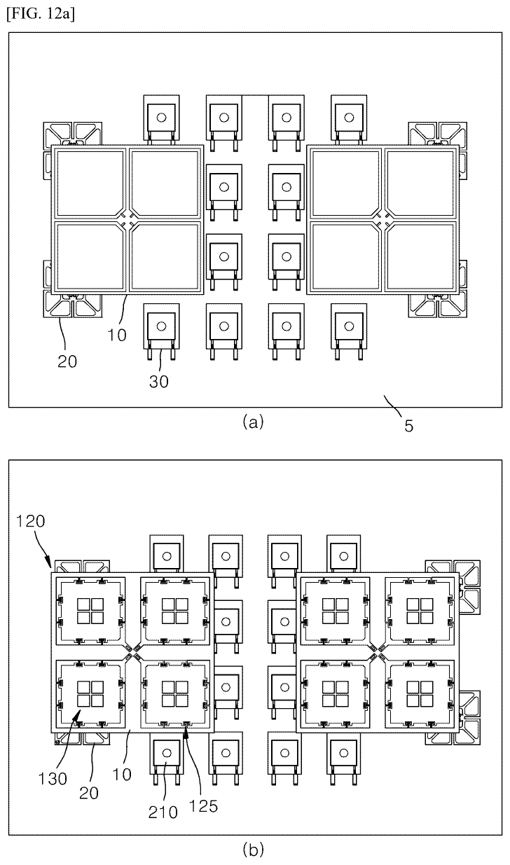

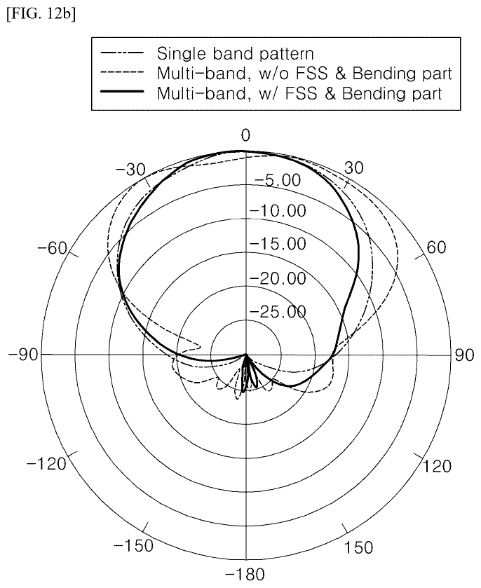

FIG. 9 is a plan view illustrating the wave-transmissible shape part among the configurations of FIG. 5, FIG. 10 is a frequency characteristic diagram illustrating the transmission band according to FIG. 9, FIG. 11 is a plan view illustrating the first to third variations of the wave-transmissible shape part of FIG. 9, FIG. 12a is an arrangement diagram of the first to third antenna patch panels according to the presence or absence of the wave-transmissible shape part according to an embodiment of the present disclosure, and FIG. 12b is a beamforming diagram reflecting the result values of beam patterns (beamforming) according to the presence or absence of the wave-transmissible shape part of FIG. 12a.

An antenna device according to an embodiment of the present disclosure, as shown in FIGS. 3 and 4, may be provided with a frequency selective transmission pattern part 100 to minimize the distortion caused by the reflection of the relatively high-frequency band beam patterns (middle beam 20B and high beam 30B) by the aforementioned first antenna patch panel 10.

Here, the frequency selective transmission pattern part 100 may be provided in a conductive pattern form on a portion of the first antenna patch panel 10 that entirely or at least partially overlaps the radiation direction of the middle beam 20B and the high beam 30B, which are relatively high-frequency band beam patterns.

More specifically, the first antenna patch panel 10 may be provided with at least one frequency selective transmission pattern part 100 for selectively transmitting at least one of the middle beam 20B radiated and formed from the second antenna patch panel 20 and the high beam 30B radiated and formed from the third antenna patch panel 30.

Here, as shown in FIGS. 5 to 7, the frequency selective transmission pattern part 100 may include an external wave-transmissible pattern 120 related to the middle beam 20B or the high beam 30B and prepared for the transmission of the middle beam 20B or the high beam 30B, and an internal wave-transmissible pattern 130 related to the middle beam 20B or the high beam 20B and prepared for the transmission of the middle beam 20B or the high beam 20B.

The radiating surface of the first antenna patch panel 10 is made of a dielectric material. Four external wave-transmissible patterns 120 (refer to reference numerals ‘120a˜120d’ in FIG. 4) may be prepared on the radiating surface of one first antenna patch panel 10 in the form of a square conductive edge 127 having a size approximately similar to the outer shape of the second antenna patch panel 20.

Here, the internal material of the conductive edge 127 of each external wave-transmissible pattern 120 is the same dielectric material as the radiating surface of the first antenna patch panel 10 described above. Four internal wave-transmissible patterns 130 may be combined to form a square conductive inner surface (not shown) having a size approximately similar to the outer shape of the third antenna patch panel 30 inside one external wave-transmissible pattern 120.

At this time, the internal wave-transmissible pattern 130 may be prepared as one conductive inner surface similar in size to the third antenna patch panel 30, or as shown in FIG. 4, it may be prepared to be separated into four (refer to reference numerals ‘130a˜130d’ in FIG. 4) square shapes.

In addition, the internal wave-transmissible pattern 130 is formed to have a square conductive inner surface and may be electrically isolated from the four external wave-transmissible patterns 120.

Meanwhile, in some of the frequency selective transmission pattern parts 100 within the first antenna patch panel 10, as shown in FIGS. 7 and 9, at least one wave-transmissible shape part 125 may be processed and formed such that its shape from the input terminal (not shown) to the output terminal (not shown) of the radiated frequency is perfectly symmetrical with respect to an arbitrary reference line T, so that the operating frequencies forming the middle beam 20B of the second antenna patch panel 20 or the high beam 30B of the third antenna patch panel 30 may be transmitted and their interference minimized.

That is, the wave-transmissible shape part 125 may be limited to being provided only in the external wave-transmissible pattern 120 which is a part of the frequency selective transmission pattern part 100 and is provided as a square conductive edge 127 on the first antenna patch panel 10.

Here, as shown in FIG. 9, the wave-transmissible shape part 125 may be formed in a wave-transmissible groove 121 which is a part of the square conductive edge 127 of the external wave-transmissible pattern 120 cut open inwardly. Therefore, the wave-transmissible shape part 125 may be provided so as not to protrude or be exposed outside the conductive edge 127 of the external wave-transmissible pattern 120.

Meanwhile, as shown in FIG. 9, the wave-transmissible shape part 125 may include a wave-transmissible end 123 having at least one bending end 129a, 129b and 129c on one side and the other side when the exact center portion between one side wall and the other side wall of the wave-transmissible groove 121 is the arbitrary reference line T, and a wave-transmissible connection end 124a and 124b extending from the wave-transmissible groove 121 and including a frequency input terminal and a frequency output terminal that respectively connect the left and right sides of the wave-transmissible end 123.

Here, the frequency input terminal and the frequency output terminal of the wave-transmissible connection end 124a and 124b may be determined differently depending on the position of the beam through which the wave is transmitted.

In addition, it is preferable that the frequency input terminal and the frequency output terminal of the wave-transmissible connection end 124a and 124b are processed and formed to be separated in a form where a part of the conductive edge 127 of the external wave-transmissible pattern 120 is cut based on the arbitrary reference line T.

Such a wave-transmissible shape part 125, referring to FIG. 9, is provided to apply the following principles related to frequency wave transmission.

More specifically, it is assumed that some of the middle beam 20B of the second antenna patch panel 20 and the high beam 30B of the third antenna patch panel 30, which are arranged behind the first antenna patch panel 10 and have their radiation direction set forward, interfere with the first antenna patch panel 10 depending on their arrangement position on the reflector 5.

In addition, for complete wave transmission through the wave-transmissible shape part 125, the length from the frequency input terminal to the frequency output terminal must be ½ of the wavelength (λ₀) of the frequency (f₀) to be transmitted. In this case, the design should ensure that the electromagnetic waves radiated from the f₀ current flowing in the conductive edge 127 of the external wave-transmissible pattern 120 have a 180° phase difference. However, it should be considered that the transmission performance may vary depending on the gap of each bending end 129a, 129b and 129c mentioned above.

This applies the principle of phase delay according to the following formula.

$$Phase delay β l = \frac{2 π}{λ} l = 180 ° = π \to ∴ l = \frac{λ}{2} \qquad ( Formula )$$

When the above phase delay principle is specifically applied, as shown in FIG. 9, the middle beam 20B or high beam 30B induced in the first antenna patch panel 10 induces a 180° phase difference during the process of being input through the frequency input terminal and output through the frequency output terminal.

That is, as shown in FIG. 9, the amplitude values of the solid arrow current and the dotted arrow current are designed to be the same, and only their phases are designed to differ by 180° (solid arrow current amplitude 1, phase +90°, dotted arrow current amplitude 1, phase −90°).

When the middle beam 20B or high beam 30B is input through the frequency input terminal of the wave-transmissible shape part 125 designed as described above, the phase difference becomes 180° by the time it is output through the frequency output terminal, thereby minimizing interference (distortion) due to reflection and enabling radiation in the optimal beam shape (beamforming) required by the designer.

For example, as shown in FIG. 10, when the frequency band to be transmitted is the high-frequency band of 3.4 GHz-3.7 GHZ (high beam 30B), if S-parameter is defined as the energy returned by resistance, S11 (thin line) is the energy value that returns to port 1 after energy starts from port 1, and S12 (thick line) is the energy value that returns to port 1 after energy starts from port 2, it may be confirmed that the S11 value, which is the practically canceled energy value, is measured below −10 dB in the frequency band to be transmitted, thereby confirming the frequency characteristics that may realize the desired beam pattern (beamforming) for the designer in that band.

Such a wave-transmissible shape part 125 may be implemented as a first embodiment 125A as shown in FIG. 11 (a).

The wave-transmissible shape part 125A according to the first embodiment is characterized in that the inner end of the wave-transmissible end 123 is formed to be entirely accommodated within the wave-transmissible groove 121.

This is because, when the permissible transmission performance is ensured by the gap between the wave-transmissible connection end 124a and 124b and each bending end 129a, 129b and 129c formed on the wave-transmissible end 123, it is most preferable that the wave-transmissible end 123 is designed not to protrude inwardly from the inner end 120I of the conductive edge 127 as much as possible.

However, the inner end of the wave-transmissible end 123 does not necessarily have to be entirely accommodated within the wave-transmissible groove 121, and as shown in FIG. 9, it may protrude by a predetermined length D1 with respect to the inner end 120I of the conductive edge 127.

In this case, the wave-transmissible shape part 125 may be formed to have at least two bending ends 129a, 129b and 129c on one side and the other side, respectively, with respect to the arbitrary reference line T, and it may be designed such that only at least two bending ends 129a and 129b of the wave-transmissible end 123 generated from the wave-transmissible connection end 124a and 124b are entirely accommodated within the wave-transmissible groove 121.

Here, it is preferable that the wave-transmissible end 123 is formed such that its inner end protrudes beyond the wave-transmissible groove 121 and into the external wave-transmissible pattern 120 with respect to the inner end 120I of the conductive edge 127, but the length of protrusion from the boundary of the wave-transmissible groove 121 (i.e., the inner end 120I of the conductive edge 127) does not exceed the depth of the wave-transmissible groove 121.

Furthermore, the wave-transmissible shape part 125 may be implemented as a second embodiment 125B as shown in FIG. 11 (b).

The wave-transmissible shape part 125B according to the second embodiment, as shown in FIG. 11 (b), may be formed in two stages (refer to reference numerals ‘125a’ and ‘125b’ in FIG. 11 (b)) such that the aforementioned wave-transmissible connection end 124 and the wave-transmissible end 123 are further added to the inner end of the wave-transmissible end 123.

In this case, the component corresponding to the wave-transmissible connection end 124a and 124b of the first stage 125a among the parts additionally formed in two stages 125b may be defined as an additional connection end 124a′ and 124b′, and the component corresponding to the wave-transmissible end 123 of the first stage 125a among the parts additionally formed in two stages 125b may be defined as an additional wave-transmissible end 123a.

As described above, the protrusion of the wave-transmissible shape part 125A into the conductive edge 127 may affect the beam pattern (beamforming) implementation. However, if it is necessary to secure a longer transmission line length depending on the frequency band to be transmitted, an additional connection end 124a′ and 124b′ and an additional wave-transmissible end 123a may be additionally formed, as in the wave-transmissible shape part 125B according to the second embodiment.

At this time, the inner end of the wave-transmissible end 123 of the first stage 125a may protrude by a predetermined length D1 from the inner end 120I of the conductive edge 127, and the inner end of the additional wave-transmissible end 123a of the second stage 125b may be formed with a length D2 that protrudes further than D1 from the inner end 120I of the conductive edge 127.

Meanwhile, the wave-transmissible shape part 125 may be implemented as a third embodiment 125C as shown in FIG. 11 (c).

The wave-transmissible shape part 125C according to the third embodiment, as shown in FIG. 11 (c), includes a middle beam wave-transmissible part 125MB related to the wave transmission of the middle beam 20B and a high beam wave-transmissible part 125HB related to the wave transmission of the high beam 30B, and the length of the inner end 123M of the middle beam wave-transmissible part 125MB may be formed to be longer than the length of the inner end 123H of the high beam wave-transmissible part 125HB.

That is, the wave-transmissible shape part 125C according to the third embodiment is configured such that two wave-transmissible shape parts 125C are respectively provided in the middle beam wave-transmissible groove 121M and the high beam wave-transmissible groove 121H formed in the conductive edge 127 for each frequency band, corresponding to the transmission line length required for wave transmission according to each frequency bandwidth, in preparation for cases where radiation beams of two or more frequency bands (e.g., middle beam 20B and high beam 30B) are simultaneously transmitted through a single first antenna patch panel 10.

The difference in beamforming appearance between when the wave-transmissible shape part 125 is not provided in the external wave-transmissible pattern 120 (refer to FIG. 12a (a)) and when it is provided (refer to FIG. 12a (b)) is as follows.

Referring to FIG. 12b, in the case of a single band where multi-band is not applied (refer to the two-dot chain line), there is almost no resonance effect of the radiated beam, so the desired beam pattern (beamforming) can be achieved. However, in the case where only the frequency selective transmission pattern part 100 is formed in the configuration of the antenna device 1 according to an embodiment of the present disclosure and the wave-transmissible shape part 125 is not applied (refer to the dotted line), severe distortion due to resonance at the radiation point can occur. In the case where the wave-transmissible shape part 125 is applied in the configuration of the antenna device 1 according to an embodiment of the present disclosure (refer to the solid line), active wave transmission occurs, enabling the realization of beam patterns (beamforming) within an acceptable range of interference.

As such, the antenna device according to an embodiment of the present disclosure, through the provision of the frequency selective transmission pattern part 100 and its detailed component, the wave-transmissible shape part 125, may minimize the distortion of multi-band radiation beam patterns, thereby providing advantages such as easy arrangement design of each antenna patch panel 10, 20 and 30 and prevention of product size expansion, as well as improving signal quality.

The antenna device according to an embodiment of the present disclosure has been described in detail above with reference to the accompanying drawings. However, it should be understood that the embodiments of the present disclosure are not necessarily limited by the described embodiment, and various modifications and equivalent implementations by those skilled in the art to which the present disclosure pertains are possible.

### INDUSTRIAL APPLICABILITY

The present disclosure provides an antenna device that minimizes interference of radiation beams between antenna patch panels configured to cover multiple frequency bands, and artificially minimizes, through a wave-transmissible shape part, the frequency that interferes with the antenna patch panel of the low-frequency band (Low Band) among the frequencies of the high-frequency band (High Band or Middle Band) radiated in the radiation direction, thereby maximizing beamforming characteristics.

1. An antenna device, comprising:
a first antenna patch panel configured to radiate an operating frequency of a first frequency band; and
at least one second antenna patch panel configured to radiate an operating frequency greater than the first frequency band,
wherein the first antenna patch panel is provided with a frequency selective transmission pattern part configured to transmit a beam of an operating frequency radiated from the second antenna patch panel (hereinafter referred to as a ‘middle beam’), and
wherein the frequency selective transmission pattern part is provided in a conductive pattern form on a portion of the first antenna patch panel that entirely or at least partially overlaps the radiation direction of the middle beam of the second antenna patch panel.

2. An antenna device, comprising:
a first antenna patch panel configured to radiate an operating frequency of a first frequency band;
at least one second antenna patch panel configured to radiate an operating frequency greater than the first frequency band; and
at least one third antenna patch panel configured to radiate an operating frequency greater than the second frequency band,
wherein the first antenna patch panel is provided with at least one frequency selective transmission pattern part configured to transmit at least one of a beam of an operating frequency radiated from the second antenna patch panel (hereinafter referred to as a ‘middle beam’) and a beam of an operating frequency radiated from the third antenna patch panel (hereinafter referred to as a ‘high beam’), and
wherein the at least one frequency selective transmission pattern part is respectively provided in a conductive pattern form on a portion of the first antenna patch panel that entirely or at least partially overlaps the radiation direction of the middle beam of the second antenna patch panel or the high beam of the third antenna patch panel.

3. The antenna device of claim 1, wherein a part of the frequency selective transmission pattern part is provided in a processed form of at least one wave-transmissible shape part formed such that its shape from the input terminal to the output terminal of the radiation frequency is perfectly symmetrical with respect to an arbitrary reference line, so that the operating frequency forming the middle beam of the second antenna patch panel is transmitted.

4. The antenna device of claim 2, wherein a part of the frequency selective transmission pattern part is provided in a processed form of at least one wave-transmissible shape part formed such that its shape from the input terminal to the output terminal of the radiation frequency is perfectly symmetrical with respect to an arbitrary reference line, so that each operating frequency forming the middle beam of the second antenna patch panel or the high beam of the third antenna patch panel is transmitted.

5. The antenna device of claim 3, wherein the frequency selective transmission pattern part comprises:
four external wave-transmissible patterns associated with the middle beam, formed to have square conductive edges and provided on the first antenna patch panel; and
four internal wave-transmissible patterns associated with the middle beam, formed to have square conductive inner surfaces, spaced apart from the four external wave-transmissible patterns by an open circuit, and provided on the first antenna patch panel as an inner part of each of the external wave-transmissible patterns,
wherein the wave-transmissible shape part is provided in the external wave-transmissible pattern.

6. The antenna device of claim 3, wherein the frequency selective transmission pattern part comprises:
four external wave-transmissible patterns associated with at least one of the middle beam and the high beam, formed to have square conductive edges and provided on the first antenna patch panel; and
four internal wave-transmissible patterns associated with at least one of the middle beam and the high beam, formed to have square conductive inner surfaces, spaced apart from the four external wave-transmissible patterns by an open circuit, and provided on the first antenna patch panel as an inner part of each of the external wave-transmissible patterns,
wherein the wave-transmissible shape part is provided in the external wave-transmissible pattern.

7. The antenna device of claim 5, wherein each of the four external wave-transmissible patterns is connected to be fed by a balun part provided to support the first antenna patch panel.

8. The antenna device of claim 5, wherein the wave-transmissible shape part is formed in a wave-transmissible groove that is a part of the square conductive edge of the external wave-transmissible pattern cut open inwardly.

9. The antenna device of claim 5, wherein the wave-transmissible shape part comprises:
a wave-transmissible end having at least one bending end on one side and the other side when the exact center portion between one side wall and the other side wall of the wave-transmissible groove is the arbitrary reference line; and
a wave-transmissible connection end extending from the wave-transmissible groove and including a frequency input terminal and a frequency output terminal that respectively connect the left and right sides of the wave-transmissible end.

10. The antenna device of claim 9, wherein the frequency input terminal and the frequency output terminal of the wave-transmissible connection end are processed and formed to be separated in a form where a part of the external wave-transmissible pattern is cut based on the arbitrary reference line.

11. The antenna device of claim 9, wherein the wave-transmissible end is formed such that its inner end is accommodated entirely within the wave-transmissible groove.

12. The antenna device of claim 9, wherein the wave-transmissible end is formed to have at least two bending ends on one side and the other side respectively with respect to the arbitrary reference line, and at least two bending ends of the wave-transmissible end generated from the wave-transmissible connection end are accommodated entirely within the wave-transmissible groove.

13. The antenna device of claim 9, wherein the wave-transmissible end is designed such that its inner end protrudes inwardly beyond the wave-transmissible groove and into the external wave-transmissible pattern, but the length of protrusion from the boundary of the wave-transmissible groove does not exceed the depth of the wave-transmissible groove.

14. The antenna device of claim 13, wherein the wave-transmissible shape part is formed in two stages such that the wave-transmissible connection end and the wave-transmissible end are further added to the inner end of the wave-transmissible end.

15. The antenna device of claim 9, wherein the wave-transmissible shape part comprises:
a middle beam wave-transmissible part related to the wave transmission of the middle beam; and
a high beam wave-transmissible part related to the wave transmission of the high beam,
wherein the length of the inner end of the middle beam wave-transmissible part is formed to be longer than the length of the inner end of the high beam wave-transmissible part.

16. The antenna device of claim 15, wherein the middle beam wave-transmissible part and the high beam wave-transmissible part are simultaneously formed to be spaced apart on the same side of the square conductive edge.
